(19) United States
(12) Patent Application Publication
(10) Pub. No.: US 2012/0091951 A1
(43) Pub. Date: Apr. 19, 2012

(54) APPARATUS AND METHOD FOR DISPLAYING MEASURED STRENGTH IN WIRELESSLY CHARGING BATTERY

(76) Inventor: Hyun Yeo SOHN, Seoul (KR)

(21) Appl. No.: 13/274,550

(22) Filed: Oct. 17, 2011

(30) Foreign Application Priority Data
Oct. 19, 2010 (KR) 10-2010-0102140

(51) Int. Cl. H02J 7/00

(52) U.S. Cl. 320/108; 320/162

(57) ABSTRACT

In an electronic apparatus for charging a battery using wireless power transmission, a receiving unit receives power wirelessly transmitted from a transmission unit of a charger pad. A power supply unit receives power from the receiving unit and uses the received power as charging power or provides the received power to a measurement unit. The measurement unit measures at least one of a power, voltage or current applied to the power supply unit through the wireless power transmission. A display unit displays an indication as to a possibility of charging or an estimated remaining charging time according to the measured one of the power, voltage, and current. A control unit provides a command to the measurement unit so as to measure the at least one of the power, voltage and current applied to the power supply unit and controls the display unit.

### CROSS-REFERENCES TO RELATED APPLICATIONS

The present application claims priority under 35 U.S.C. 119(a) to Korean Application No. 10-2010-0102140, filed on Oct. 19, 2010, in the Korean Intellectual Property Office, which is incorporated herein by reference in its entirety set forth in full.

### BACKGROUND

Exemplary embodiments of the present invention relate to battery charging of an electronic apparatus using a wireless power transmission technology, and more particularly, to an apparatus and a method for displaying a power strength and an estimated charging time in wireless charging of a battery.

Secondary power cells (batteries) are used as power sources of portable electronic apparatuses, and use of wireless power transmission technology for charging batteries would be useful.

In using the wireless power transmission, if an electronic apparatus is put on a charger pad, a battery of the electronic apparatus is charged without connecting the charger pad to a separate wired connector for providing power. The wireless power transmission technology has been applied to electric toothbrushes and electric shavers. Here, since a wired charger is unnecessary, use of a wired connector of an electronic apparatus to a power supply is avoided, and thus the electronic apparatus can be designed without constraints of having a wired power supply connector.

An electromagnetic induction method using a coil and a resonance method are examples of the wireless power transmission technology.

In using the electromagnetic induction method, power is transmitted between a coil at the side of a charger pad (transmission unit) and a coil at the side of an electronic apparatus (receiving unit). Here, if a magnetic field is generated from the transmission unit (charger pad), electricity is produced through generation of induction current in the receiving unit (electronic apparatus), thereby generating power. The electromagnetic induction method is easily implemented and may be applied for charging electric toothbrushes and electric shavers. However, if the position of the coil of the transmission unit is not properly matched to that of the coil of the receiving unit, charging may not be performed.

On the other hand, in using the resonance method, the principle of resonance-type power transmission is relied on. Even if the distance between coils may be a few meters or farther, power may be transmitted using the resonance method. Here, the power transmission is performed by allowing an electromagnetic wave to be resonant at a desired frequency using a resonator, where charging may be performed even if the relative positions of coils are less than precise.

A conventional wireless power transmission technology will be described as follows.

FIG. 1 illustrates an internal configuration of an apparatus for charging a battery through wireless power transmission using an electromagnetic induction method. A charger pad 100 for transmitting power generates a magnetic field through a first coil 104 connected to a control unit 102. An electronic apparatus 200 for receiving power receives power through a second coil 202 located in a receiver as transmitted through the magnetic field generated through the first coil 104 in the charger pad 100 and transferred as the magnetic field generated through the second coil 202. The power generated through the second coil 202 is applied to a power supply unit 204 of the electronic apparatus 200, and the power supply unit 204 charges a battery 206 using the applied power. In the electromagnetic induction method, the power transmission occurs when the first and second coils 104 and 202 are properly aligned. However, the proper alignment may not be always made, where the alignment state can be determined through flickers of an LED (not shown) of the charger pad 100. The electronic apparatus 200 is configured to indicate whether or not the charging of the battery 206 has been completed by using different colors (for example, by varying the intensity or color) of an LED (not shown) of the electronic apparatus 200. However, in a case where the completion progress of charge is indicated through the colors of the LED only, a user may not accurately determine the completion degree of charge and the remaining time for completing the charge. Further, it is difficult to determine how efficient for charge the current alignment/position of the electronic device is.

### SUMMARY

An embodiment of the present invention relates to an apparatus and method for measuring a strength of power currently supplied to an electronic apparatus for charging a battery through wireless power transmission so as to display the measured strength of power, and calculating an estimated charging time based on the measured strength of power so as to display the calculated estimated charging time.

Another embodiment of the present invention relates to an apparatus and method for enabling a user to effectively use a charging time by controlling the position of an electronic apparatus on a charger pad according to a measured strength of power.

In one embodiment, an electronic apparatus for charging a battery using wireless power transmission includes a receiving unit configured to receive wireless transmitted power; a power supply unit configured to use the received power for charging and provide the received power to a measurement unit; the measurement unit configured to measure at least one of a power, voltage, and current applied to the power supply unit through the wireless power transmission; a display unit configured to display an indication as to a possibility of charging or an estimated remaining charging time according to the measured one of the power, voltage, and current; and a control unit configured to provide a command to the measurement unit so as to measure the at least one of the power, voltage and current applied to the power supply unit and control the display unit to display the indication as to the possibility of charging or the estimated charging time according to the measured one of the power, voltage or current applied to the power supply unit.

In another embodiment, an electronic apparatus for charging a battery using wireless power transmission includes a receiving unit configured to receive wirelessly transmitted power; a power supply unit configured to use the received power for charging and provide the received power to a measurement unit; the measurement unit configured to measure at least one of a power, voltage, and current applied to the power supply unit through the wireless power transmission; a display unit configured to display a value or strength received from the measurement unit; and a control unit configured to provide a control command to the measurement unit so as to measure the at least one of the power, voltage, and current applied to the power supply unit and control the display unit to display the value or strength received from the measurement unit.

In another embodiment, a method for charging a battery using wireless power transmission includes receiving, by an electronic apparatus, wirelessly transmitted power; measuring at least one of a power, voltage, and current received through the wireless power transmission; calculating an estimated charging time corresponding to the measured one of the power, voltage, and current; and displaying the calculated estimated charging time or a possibility of charging in a display unit.

In another embodiment, a method for charging a battery using wireless power transmission includes receiving, by an electronic apparatus, wirelessly transmitted power; measuring a strength of at least one of a power, voltage, and current received through the wireless power transmission; and displaying the measured strength of the at least one of the power, voltage, and current in a display unit.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram illustrating an internal configuration of a conventional wireless power transmitter and receiver using an electromagnetic induction method;

FIG. 2 illustrates electronic apparatuses for wireless charging using wireless power transmission;

FIG. 3 is a block diagram illustrating an internal configuration of an electronic apparatus having a transmitter and a receiver using wireless power transmission according to an embodiment of the present invention;

FIG. 4A illustrates a single square-loop structure;

FIG. 4B illustrates a square spiral structure;

FIG. 4C illustrates a solenoid structure;

FIG. 4D illustrates an equal-spaced spiral structure;

FIG. 4E illustrates a serial triple spiral structure with unequal spaces;

FIG. 5A illustrates a screen displayed in a display unit according to an embodiment of the present invention; and

FIG. 5B illustrates a screen displayed in the display unit according to an embodiment of the present invention.

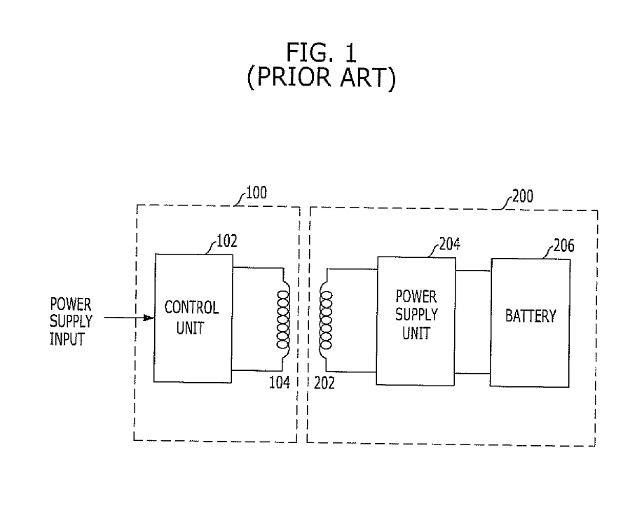

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

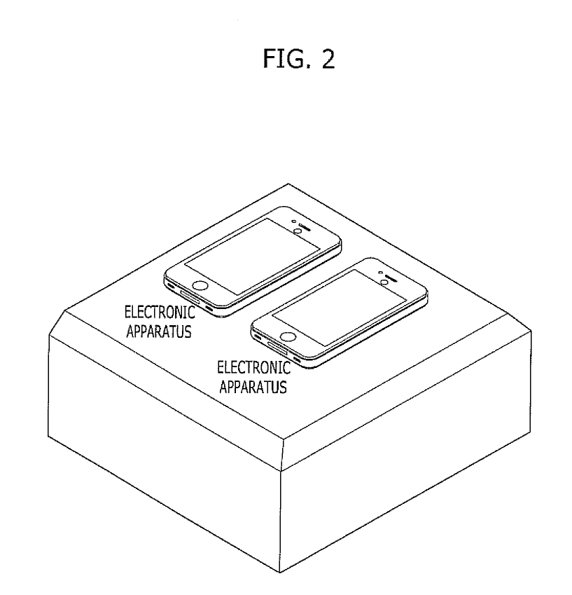

FIG. 2 illustrates electronic apparatuses for wireless charging using wireless power transmission.

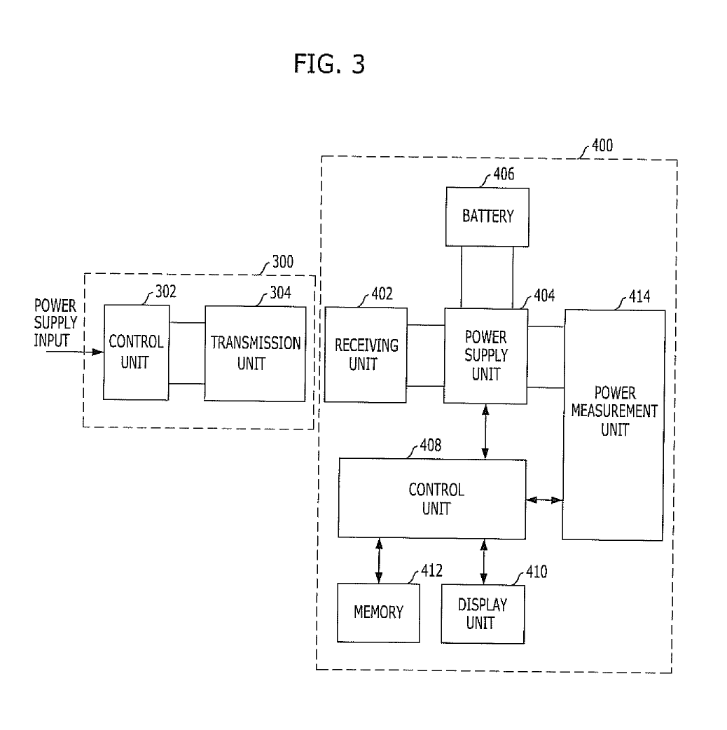

FIG. 3 is a block diagram illustrating an internal configuration of an electronic apparatus having a transmitter and a receiver using wireless power transmission according to an embodiment of the present invention. The internal configuration of a charger pad 300 for power transmission and an electronic apparatus 400 for receiving power is illustrated in FIG. 3.

Referring to FIG. 3, the charger pad 300 for wireless power transmission includes a control unit 302 and a transmission unit 304. The control unit 302 converts power received from a power source into power for transmission and applies the converted power to the transmission unit 304. The control unit 302 controls functions of the charger pad 300, including switching on/off of the charger pad 300, display of charging completion, etc. The power applied to the transmission unit 304 is transmitted to a receiving unit 402 at the side of the electronic apparatus 400 from the transmission unit 304.

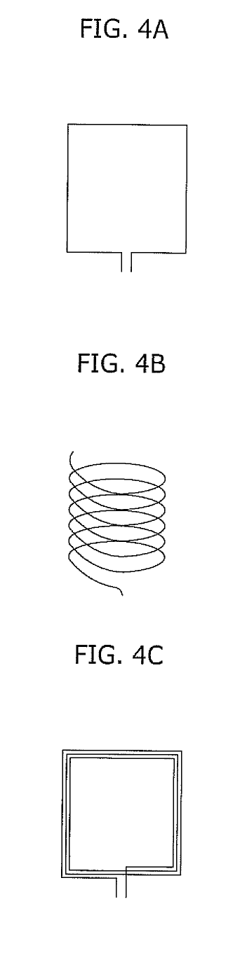

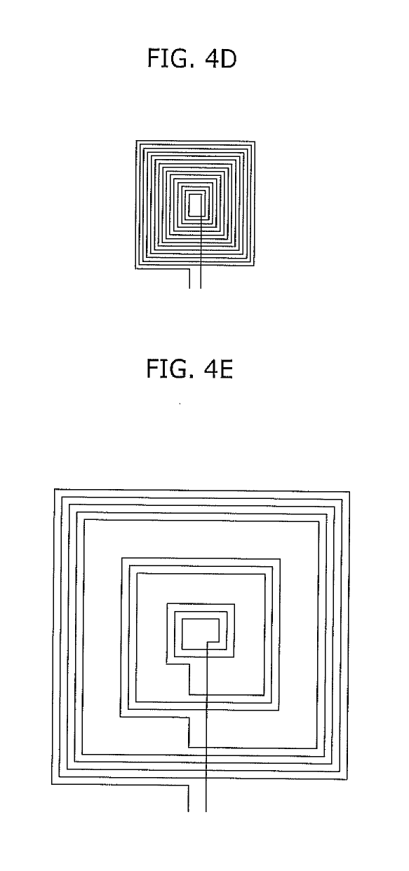

The transmission unit 304 and the receiving unit 402 may be implemented in various forms. Although the transmission unit 304 and the receiving unit 402 are generally configured as coils as described above in illustrating the background of the invention, exemplary embodiments of the present invention are not limited thereto. For example, the transmission unit 304 and the receiving unit 402 may be implemented using various structures such as a single square Loop structure of FIG. 4A, a square spiral structure of FIG. 4B, a solenoid structure of FIG. 4C, an equal-spaced spiral structure of FIG. 4D, a serial triple spiral structure of FIG. 4E with unequal spaces, etc. Although the square spiral structure has been illustrated in FIG. 4B, it will be apparent by those skilled in the art that the shape of the square spiral structure may be implemented in various other shapes including a circle, a triangle, and the like. The transmission unit 304 and the receiving unit 402 may be respectively mounted in the charger pad 300 and the electronic apparatus 400, where the transmission and receiving units 304 and 402 may be implemented with a printed circuit board (PCB) substrate or the like.

The electronic apparatus 400 for receiving power includes the receiving unit 402, a power supply unit 404, a battery 406 that is a secondary battery, a control unit 408, a display unit 410, a memory 412 and a power measurement unit 414. The power received through the receiving unit 402 of the electronic apparatus 400, where the power is originally transmitted from the transmission unit 304 of the charger pad 300, is applied to the power supply unit 404. The power supply unit 404 charges the battery 406, which serves as a secondary/auxiliary power cell, with the supplied power. The control unit 408 controls the power measurement unit 414 to measure the magnitude of the power received from the power supply unit 404 and controls the display unit 410 to display the measured power as a power strength supplied for charge. Although the power measurement unit 414 has been separately illustrated in FIG. 3, the power measurement unit 414 may be positioned in the control unit 408 or the power supply unit 404.

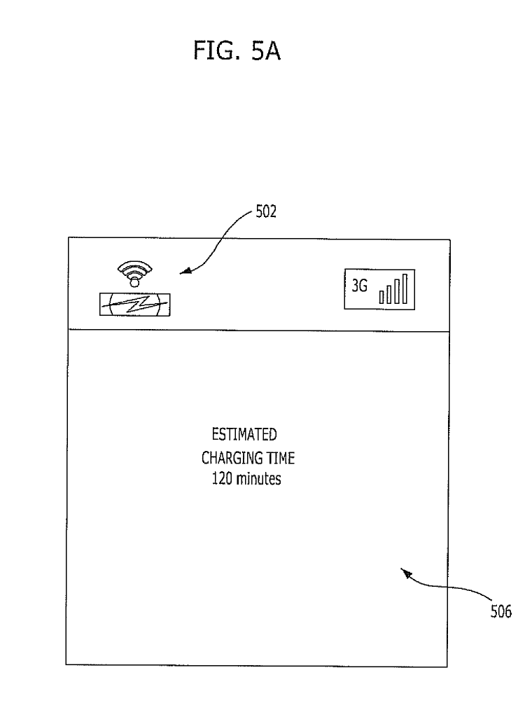

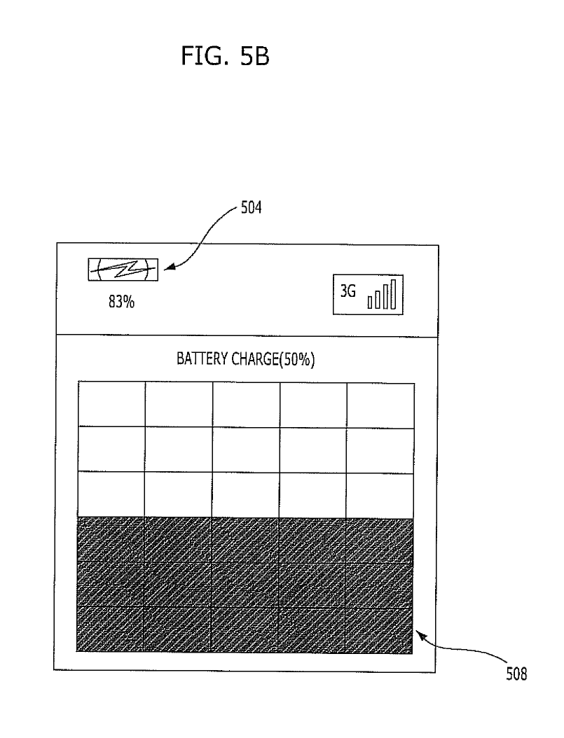

The power strength may be indicated by icon 502 in the display unit (410) as illustrated in FIG. 5A or by FIG. 504 or percentage (%) numeral as illustrated in FIG. 5B. Here, a user may search for a position at which the charging efficiency is the highest by changing the position of the electronic apparatus 400 depending on the displayed power strength (that is, to be at a position where the power strength is the highest).

In a case where power is measured in the power measurement unit 414, the control unit 408 converts the measured power into a voltage and compares the converted voltage with a table of estimated charging times for each voltage. Subsequently, the control unit 408 controls the display unit 410 to display a corresponding estimated charging time. The power measurement unit 414 operates as a measurement unit for measuring a voltage, a current, any other value corresponding to the foregoing values, or a combination of one or more of the foregoing values. A configuration of the measurement unit may be implemented by using any one of well-known configurations.

The table of estimated charging times for each voltage according to an example may be as follows in Table 1.

TABLE 1

| Measured | Estimated | |
|---|---|---|
| voltage | charging time | Estimated charging time |
| 0~2.5 | ∞ | Charging is impossible |
| 2.5~2.7 | 240 | Estimated charging time is 4 hours |
| 2.7~3.0 | 120 | Estimated charging time is 2 hours |
| 3.0~3.5 | 100 | Estimated charging time is 1 hour 40 |
| | | minutes |
| 3.5~4.5 | 60 | Estimated charging time is 1 hour |
| 4.5~5.0 | 50 | Estimated charging time is 50 minutes |

The table in Table 1 may not be accurate and are exemplary only. Values in Table 1 may vary according to the capacity of the battery 406 of the electronic apparatus 400 and the amount of power transmitted from the charger pad 300. In Table 1, the discharge state of the battery 406 is determined based on an estimated charging time. Here, if the remaining amount of battery 406 is 50%, the estimated charging time may be divided into half in the table so that the half of the estimated charging time is displayed in the display unit 410. Alternatively, another table corresponding to 50% as the remaining amount of the battery 406 is configured, and the estimated charging time may be displayed using the table.

According to an example, when the charging of the battery 406 of the electronic apparatus 400 is first started, the control unit 408 controls the display unit 410 to display an estimated charging time using the table. Then, if the charging of the battery 406 starts, the control unit 408 controls the display unit 410 to display the estimated charging time while properly decreasing the estimated charging time according to the amount of power charged in the battery 406 (by measuring the charged amount by detecting for example, a voltage, current, or power supplied from the battery 406) and the amount of power currently transmitted.

Here, when the amount of power received by the electronic apparatus 400 is changed due to a change in the position of the electronic apparatus 400 or a change in the amount of power transmitted from the charger pad 300, the estimated charging time of the corresponding amount of power may be re-calculated and displayed in the display unit 410.

If it is difficult to calculate an estimated charging time according to the total charge in the battery 406 at the time, times of the table in Table 1 may be counted down and displayed in the display unit 410. That is, if the charging time corresponding to the amount of power that the electronic apparatus 400 initially receives as transmitted from the charger pad 300 is 60 minutes, 60 minutes may be counted down from this time during the period that the power is received by the electronic apparatus 400. However, the amount of power transmitted from the charger pad 300 may be changed due to a change in the position of the electronic apparatus 400 during the charging of the battery 406.

The estimated charging time may be indicated through estimated charging time 506 in the display unit 410 as illustrated in FIG. 5A or as a graphical expression 508 in the display unit 410 as illustrated in FIG. 5B.

According to exemplary embodiments of the present invention, when a battery of an electronic apparatus is charged using wireless power transmission, a user may be aided in placing the electronic apparatus at a position with the highest charging efficiency by displaying the strength of power received by the electronic apparatus. Further, an indicia indicating an estimated remaining charge time may be displayed.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. An electronic apparatus for charging a battery using wireless power transmission, the apparatus comprising:
a receiving unit configured to receive wireless transmitted power;
a power supply unit configured to use the received power for charging or provide the received power to a measurement unit;
the measurement unit configured to measure at least one of a power, voltage, and current applied to the power supply unit through the wireless power transmission;
a display unit configured to display an indication as to a possibility of charging or an estimated remaining charging time according to the measured one of the power, voltage, and current; and
a control unit configured to provide a command to the measurement unit so as to measure the at least one of the power, voltage and current applied to the power supply unit and control the display unit to display the indication as to the possibility of charging or the estimated charging time according to the measured one of the power, voltage or current applied to the power supply unit.

2. The apparatus of claim 1, wherein a memory is provided in the control unit and data on estimated charging times corresponding to the at least one of the measured power, voltage and current are stored in the memory.

3. The apparatus of claim 1, wherein the receiving unit is further configured to wirelessly receive the power through induction or a resonating signal.

4. The apparatus of claim 1, wherein the control unit is configured to correct the estimated charging time by determining the total charged amount of the battery and measuring a magnitude of the at least one of the power, voltage, and current applied to the power supply unit.

5. The apparatus of claim 1, wherein the receiving unit is configured to have at least one of a loop-shaped structure, a spiral-shaped structure and a solenoid-shaped structure.

6. The apparatus of claim 1, wherein the receiving unit is a printed circuit board (PCB).

7. An electronic apparatus for charging a battery using wireless power transmission, the apparatus comprising:
a receiving unit configured to receive wirelessly transmitted power;
a power supply unit configured to use the received power for charging or provide the received power to a measurement unit;
the measurement unit configured to measure at least one of a power, voltage, and current applied to the power supply unit through the wireless power transmission;
a display unit configured to display a value or strength received from the measurement unit; and
a control unit configured to provide a control command to the measurement unit so as to measure the at least one of the power, voltage, and current applied to the power supply unit and control the display unit to display the value or strength received from the measurement unit.

8. The apparatus of claim 7, wherein the value received from the measurement unit is the measured one of the power, voltage, and current.

9. The apparatus of claim 7, wherein the display unit for displaying the value or the strength received from the measured unit is configured to display the received value or strength as a numerical value or icon.

10. The apparatus of claim 7, further comprising a memory configured to store a numerical value or icon to be displayed in the display unit.

11. The apparatus of claim 7, wherein the measured one of the power, voltage or current is measured again after a period of time passes from a first measurement of the same.

12. A method for charging a battery using wireless power transmission, the method comprising:
receiving, by an electronic apparatus, wirelessly transmitted power;
measuring at least one of a power, voltage, and current received through the wireless power transmission;
calculating an estimated charging time corresponding to the measured one of the power, voltage, and current; and
displaying the calculated estimated charging time or a possibility of charging in a display unit.

13. The method of claim 12, wherein data on estimated charging times is stored in a memory so as to calculate the estimated charging time based on the measured one of the power, voltage, and current.

14. The method of claim 12, wherein the receiving of the wirelessly transmitted power includes receiving the power through induction or a resonating signal.

15. The method of claim 12, wherein the estimated charging time is corrected and displayed by determining the total charged amount of the battery and measuring a magnitude of the at least one of the power, voltage, and current applied through the wireless power transmission.

16. A method for charging a battery using wireless power transmission, the method comprising:
receiving, by an electronic apparatus, wirelessly transmitted power;
measuring a strength of at least one of a power, voltage, and current received through the wireless power transmission; and
displaying the measured strength of the at least one of the power, voltage, and current in a display unit.

17. The method of claim 16, wherein the measured strength of the at least one of the power, voltage, and current varies depending on relative locations of the electronic apparatus from a charger pad that wirelessly transmit the power.

18. The method of claim 16, wherein the measured strength is displayed as a numerical value or icon in the display unit.

19. The method of claim 16, wherein the strength of the at least one of the power, voltage or current received through the wireless power transmission is measured again after a first measurement of the same and the measured strengths are displayed in the display unit.

20. The method of claim 16, wherein an estimated charging time determined based on the measured strength of the at least one of the power, voltage, and current received through the wireless power transmission is counted down from the time of the measurement.
